(19) United States
(12) Patent Application Publication
(10) Pub. No.: US 2026/0080276 A1
(43) Pub. Date: Mar. 19, 2026

(54) SYSTEM AND METHOD FOR PARALLELIZING LORAS BY MAXIMIZING GPU UTILIZATION

(71) Applicant: Dell Products L.P., Round Rock, TX (US)

(72) Inventors: Asser Mazin, Cairo (EG); Mohamed Hatem, Cairo (EG)

(21) Appl. No.: 18/889,195

(22) Filed: Sep. 18, 2024

(51) Int. Cl. G06N 5/04

(52) U.S. Cl. CPC G06N 5/04

(57) ABSTRACT

One example method includes receiving multiple LoRA (low rank adaptor) models, batching the LoRA models together to generate one or more batches of the LoRA models, creating a respective queue for each of the batches of the LoRA models, calling the LoRA models in a sequence in which the LoRA models were batched, and using only a single GPU (graphics processing unit), performing simultaneous parallel inferencing on all of the LoRA models.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to large language models (LLMs). More particularly, at least some embodiments relate to systems, hardware, software, computer-readable media, and methods, for maximizing graphics processing unit (GPU) utilization when tuning an LLM.

### BACKGROUND

Several natural language processing applications rely on the adaptation of a single, large pre-trained language model for various specific tasks. This adaptation process usually involves fine-tuning, which results in updates to all the parameters of the original pre-trained model. One significant drawback of fine-tuning is that the resulting model retains the same number of parameters as the initial model. This issue goes from being a minor inconvenience for models like GPT-2 or ROBERTa to a critical challenge in the deployment of GPT-3, which boasts a massive 175 billion trainable parameters and is frequently updated with even larger models.

To address this challenge, many have sought to reduce the storage and computational burden by only adapting a subset of the parameters or by incorporating external modules for new tasks. This approach enables the storage and loading of only a few task-specific parameters in addition to the pre-trained model, significantly enhancing operational efficiency during deployment. However, these existing techniques often introduce delays in inference by increasing model depth or limiting the usable sequence length. More importantly, these methods frequently fall short of matching the performance of fine-tuning, creating a trade-off between efficiency and model quality (as shown in FIG. 1, discussed below).

In contrast with full fine-tuning where every model weight is updated during supervised learning, parameter efficient fine-tuning (PEFT) methods only update a small subset of parameters. Some path techniques freeze most of the model weights and focus on fine tuning a subset of existing model parameters, for example, particular layers or components. Other techniques do not touch the original model weights at all, and instead add a small number of new parameters or layers and fine-tune only the new components. With PEFT, most, if not all, of the LLM weights are kept frozen. As a result, the number of trained parameters is much smaller than the number of parameters in the original LLM. In some cases, just 15-20% of the original LLM weights. This makes the memory requirements for training much more manageable. In fact, PEFT can often be performed on a single GPU. And because the original LLM is only slightly modified or left unchanged, PEFT is less prone to the catastrophic forgetting problems of full fine-tuning, where catastrophic forgetting is a phenomenon in which an artificial neural network abruptly and drastically forgets previously learned information upon learning new information.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of PEFT (parameter efficient fine-tuning) tradeoffs.

FIG. 2 discloses aspects of three different classes of PEFT methods.

FIG. 3 discloses a visual representation of how a Low Rank Adapter (LoRA) works.

FIG. 4 discloses an illustrative example of LORA using a base transformer as a reference.

FIG. 5 discloses the utilization of a LoRA for differing tasks.

FIG. 6 discloses a method according to one example embodiment.

FIG. 7 discloses a computing entity configured and operable to perform any of the disclosed methods, processes, and operations.

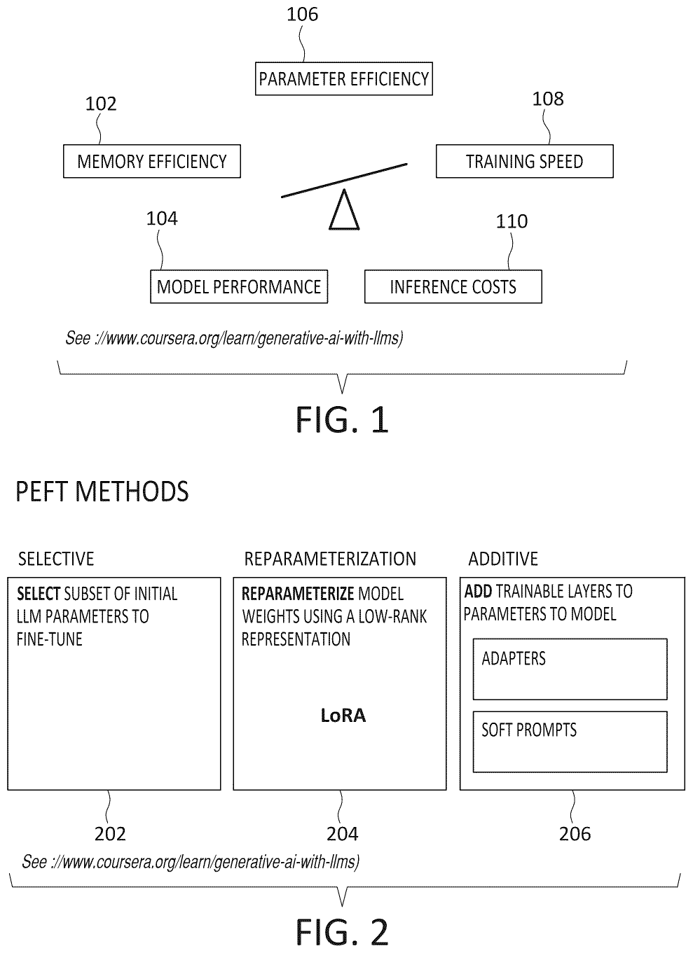

It is noted that FIGS. 1 through 5 are from a Coursera course named “Generative AI with Large Language Models” (https://www.coursera.org/learn/generative-ai-with-llms). All copyrights in those FIGS. 1 through 5 are reserved in their entirety by their respective owner(s).

### DETAILED DESCRIPTION OF SOME EXAMPLE EMBODIMENTS

Embodiments disclosed herein generally relate to large language models (LLMs). More particularly, at least some embodiments relate to systems, hardware, software, computer-readable media, and methods, for maximizing graphics processing unit (GPU) utilization when tuning an LLM.

One or more example embodiments may be performed in connection with the training, and/or fine-tuning, of an LLM. One example embodiment may provide for optimized use of resources, such as one or more GPUs for example, utilized in the fine-tuning of an LLM. Thus, an embodiment may comprise a method that, among other things, improves the efficiency with which computing resources, such as processors, are used. One embodiment may comprise a method for batching multiple LoRA (Low-Rank Adaptation) models to maximize GPU utilization for parallel inferencing. An embodiment of one such method may comprise the following operations: gathering multiple LoRA models with different respective input shapes; batching the LORA models together based on their output shapes; establishing a queue based on the output shape of the batched models; performing, on a GPU, parallel inferencing with the batched models, where the parallel inferencing comprises; (1) calling the LoRA models in the sequence in which the LoRA models were batched; and (2) performing the parallel inferencing on the LoRA models concurrently. In one embodiment, the aforementioned method may maximize utilization of the GPU. Thus, the system may achieve high throughput while reducing the time required for inferencing to be performed.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that GPU utilization may be optimized for an LLM inferencing process performed using the GPU. An embodiment may reduce, relative to approaches not employing the disclosed method(s), the amount of time needed for an LLM to perform an inferencing process. Various other advantages of one or more example embodiments will be apparent from this disclosure.

### A. Context for an Example Embodiment

The following is a discussion of aspects of an example context for one or more embodiments. This discussion is not intended to limit the scope of the claims or this disclosure, or the applicability of the embodiments, in any way.

### A.1 Introduction

As noted earlier, and with reference now to the example of FIG. 1, conventional methods frequently fall short of matching the performance of fine-tuning, creating a trade-off between, for example, memory efficiency 102 and model quality 104. Various other considerations may factor into the tradeoffs as well including, for example, parameter efficiency 106, LLM training speed 108, and inference costs 110.

### A.2 Glossary

| Term | Definition |
|---|---|
| LoRA | Low Rank Adapters |
| GPU | Graphical Processing Unit |
| GPT | Generative Pretrained Transformer |
| RoBERTa | Robustly Optimized BERT (Bidirectional Encoder |
| | Representations from Transformers) Pretraining Approach |
| PEFT | Parameter Efficient Fine Tuning |
| LLM | Large Language Model |
| AI COE | Artificial Intelligence Center of Excellence |
| LLaMA | Large Language Model Meta AI |
| VRAM | Virtual Random Access Memory |

### A.3 Discussion

Full fine-tuning of a model such as an LLM results in a new version of the model for every task that the model was trained on. Each of these is the same size as the original model, so it can create an expensive storage problem when performing fine-tuning for multiple tasks. PEFT can improve this situation by training only a small number of weights, which results in a much smaller footprint overall, as small as using only megabytes for storage, depending on the task. The new parameters are combined with the original LLM weights for inference. The PEFT weights are trained for each task and can be easily swapped out for inference, enabling efficient adaptation of the original model to multiple tasks. Swapping PEFT weights on a single GPU is an effective adjustment, but it leads to frequent context switching and inference time overhead. Consequently, adopting a single PEFT weight on one GPU is not a practical solution. Given the small size of PEFT weights, a more viable approach involves consolidating all these weights, trained for various tasks, into a single batch on a single GPU.

As shown in the example of FIG. 2, there are three main classes of Parameter Efficient Fine-Tuning (PEFT). These are: (1) Selective methods 202: identify which parameters you want to update, train only certain components of the model or specific layers, even individual parameter types; (2) Reparameterization methods 204: reduce the number of trainable parameters through low-rank approximations; and (3) Additive methods 206: carry out fine-tuning by keeping all the original LLM weights frozen and introducing new trainable components. Adapter methods add new trainable layers to the architecture of the model, typically inside the encoder or decoder components after the attention or feed-forward layers.

In one embodiment, the focus is specifically on the re-parameterization methods, since the output of this subgroup of PEFT methods are controllable as such methods are expected to have the same weights dimensionality as the base or the full fine-tuned model, there are several re-parameterization methods as LoRA, AdaLoRA, LLAMA Adapter, Infused Adapter by Inhibiting and Amplifying Inner Activations (IA3), though the most explainable one of them is LORA, discussed in detail below. Such discussion will address how LoRA works, and the process of fitting multiple LoRAs trained on multiple different tasks from the same base model into a single batch within one GPU.

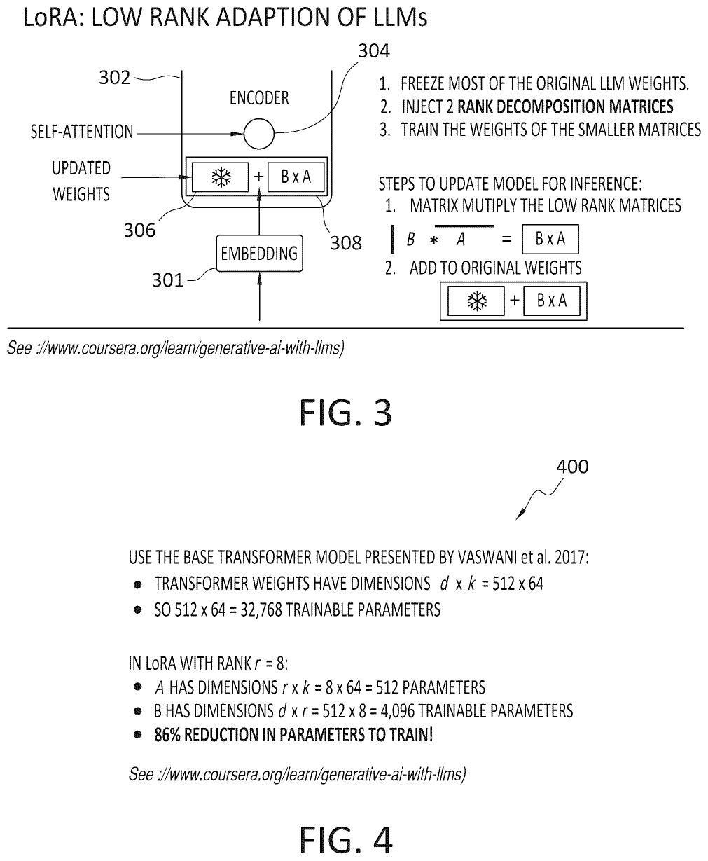

Low-rank Adaptation, or LoRA for short, is a parameter-efficient fine-tuning technique that falls into the re-parameterization category. Let us look at how it works, the diagram of a transformer architecture 300 is shown FIG. 3. The input prompt is turned into tokens, which are then converted to embedding vectors 301 and passed into an encoder 302 and/or decoder parts of the transformer. In both components, there are two kinds of neural networks: a self-attention network 304 and a feedforward network. The weights of these networks are learned during pre-training. After the embedding vectors are created, they are fed into the self-attention network 304 layers where a series of weights, later updated to weights 306, are applied to calculate the attention scores. During full fine-tuning, every parameter in these self-attention network 304 layers is updated. LoRA is a strategy that reduces the number of parameters to be trained during fine-tuning by freezing all the original model parameters and then injecting a pair of rank decomposition matrices 308 alongside the original weights.

The dimensions of the smaller matrices are set so that their product is a matrix with the same dimensions as the weights they are modifying. The original weights of the LLM are kept frozen and the smaller matrices trained using the same supervised conventional learning process. For inference, and as shown in FIG. 3, the two low-rank matrices are multiplied together to create a matrix with the same dimensions as the frozen weights. These low-rank matrices are then added to the original weights and replace them in the model with these updated values. These processes thus produce a LoRA fine-tuned model that can carry out a specific task. Because this model has the same number of parameters as the original, there is little to no impact on inference latency, that is, the speed with which inferencing is performed by the LoRA fine-tuned LLM.

Applying LoRA to only the self-attention layers of an LLM is often enough to adequately fine-tune the LLM for a task, and to achieve performance gains. In principle however, LoRA on other components may be used like the feed-forward layers. But since most of the parameters of LLMs are in the attention layers, the biggest savings in trainable parameters may be obtained by applying LoRA to these weights matrices.

With reference now to the illustrative example 400 disclosed in FIG. 4, consider a practical example using the transformer architecture described in “Vaswani, Ashish, et al. ‘Attention is all you need.’ Advances in neural information processing systems 30 (2017)” (“Vaswani”), which is incorporated herein in its entirety by this reference. Vaswani specifies that the transformer weights have dimensions of 512 by 64. This means that each weights matrix has 32,768 trainable parameters. If LORA is used as a fine-tuning method with the rank equal to eight, two small rank decomposition matrices, whose small dimension is eight, may instead be trained.

This means that Matrix A, see FIGS. 3 and 4, will have dimensions of 8 by 64, resulting in 512 total parameters. Matrix B will have dimensions of 512 by 8, or 4,096 trainable parameters. By updating the weights of these new low-rank matrices instead of the original weights, only 4,608 parameters will be trained, instead of 32,768, an 86% reduction. Because LoRA enables a significant reduction in the number of trainable parameters, this method of parameter efficient fine tuning can often be performed with a single GPU, thus avoiding the need for a distributed cluster comprising multiple GPUs. Since the rank-decomposition matrices are small, a different set can be fine-tuned for each task and then switched out at inference time by updating the weights.

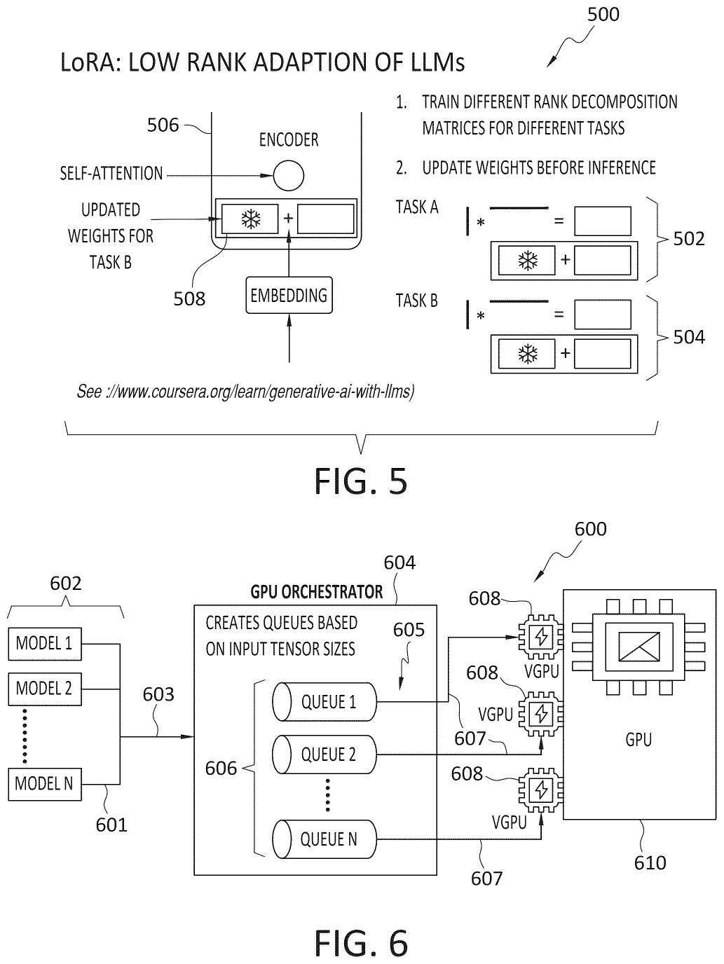

With reference now to the example 500 of FIG. 5, consider a case where a pair of LoRA matrices is trained for a specific task, Task A 502. To carry out inference on this task, these matrices would be multiplied together and then add the resulting matrix to the original frozen weights. These new summed weights matrix would then replace the original weights where they appear in the model. This model may then be used to carry out inference on Task A. If instead, a different task is to be carried out, say Task B 504, the product of the LoRA matrices trained for this task may be calculated, and then this matrix then added to the original weights and the model 506 updated again with the updated weights 508 for Task B. The memory required to store these LoRA matrices is very small.

A.3.1 to Utilize a Single GPU for Batching, this Requires the Same Input Shape

In computer architecture, context switching refers to the process of switching between different tasks or processes. This can be time-consuming and lead to performance degradation. A context switch can occur as a result of an interrupt, such as when a task needs to access disk storage, freeing up GPU time for other tasks. Some operating systems also require a context switch to move between user mode and kernel mode tasks. The process of context switching can have a negative impact on system performance. Hardware context switching does not save all the registers, only general-purpose registers, not floating-point registers. The process of context switching can be resource-intensive, and most operating system designers try to reduce the need for a context switch. They can be software or hardware governed depending upon the GPU architecture. Context switches can relate to either a process switch, a thread switch within a process, or a register switch. To improve efficiency, it is typically recommended to minimize context switching and maximize GPU utilization.

This approach limits the utilization of a single GPU because it is now bound to a specific shape from the model. The current way this is handled is by swapping the current batch (different model) with another model waiting to be processed.

A.3.2 Context Switching with Different Model Inputs

The current process is inefficient due to excessive context switching and underutilization of GPU processing time. Context switching refers to the process of switching between different tasks or processes, which can be time-consuming and lead to performance degradation. GPUs are designed to handle parallel processing, and underutilization of GPU processing time can lead to a waste of computational resources. Thus, as noted above, efficiency may be improved by minimizing context switching and maximize GPU utilization.

### B. Detailed Discussion of Aspects of One Example Embodiment

The use of multiple LoRAs fine-tuned on different tasks from the same base model while inferencing is restricted to switching out the weights when they are needed to be used, and avoiding having to store multiple full-size versions of the LLM. Thus, an embodiment may enhance GPU utilization by directing inference through multiple LoRAs within the same batch, as low-rank layer adapters have a small number of trainable parameters, all of which can be simultaneously accommodated in Virtual Random Access Memory (VRAM). An embodiment may make use of the compact nature of LoRAs and their capability to fit into the VRAM, enabling simultaneous inference execution on all adapters while maximizing the utilization of our GPU.

The LoRA operation may be straightforward. Particularly, the LoRA operation generates an output with the same dimensions as the adapted layer and then combines them. This process can be broadcasted, provided there is the same number of LORA adapters, an embodiment may create an operator to apply to each respective batch. This enables the parallel usage of multiple models that share the same weights from the original base model. By batching LoRAs with the same set of weights, an embodiment may now streamline different models to different customers at the same time while still preventing context switching, significantly decreasing inference time, and maximizing GPU utilization.

With attention now to FIG. 6, an example method 600 according to one embodiment is disclosed. In general, the method 600 may operate to leverage the power of GPUs for machine learning tasks by efficiently managing resources and ensuring that the hardware is used to its full potential. The process not only enhances performance but also contributes to cost-effectiveness by reducing the need for multiple GPUs.

In an embodiment, the method 600 may be performed in connection with various components, each of which may comprise hardware and/or software. Such components may comprise, for example, one or more LLMs 602, a GPU orchestrator 604 that may comprise and/or define one or more queues 606, processors 608 such as VGPUs (virtual GPUs), and one or more GPUs 610. In one embodiment, the VGPU(s) may serve as an abstraction or abstraction layer by way of which the underlying GPU(s) 610 may be accessed by the GPU orchestrator 604. Depending upon the embodiment, the VGPU(s) 608 may, or may not, be integrated together with the GPU(s) 610 in a single platform. In one embodiment, the orchestrator 604 may be hosted on a stand-alone platform by itself while, in another embodiment, the orchestrator 604 may be integrated together with the VGPU(s) 608 and/or the GPU(s) 610. More generally however, the scope of this disclosure is not limited to any particular arrangement or configuration of the components indicated in FIG. 6.

With continued reference to FIG. 6, the method 600 may comprise a multi-stage process for batching multiple LoRA (Low-Rank Adaptation) models to maximize GPU utilization for parallel inferencing. In one embodiment the method 600 may comprise the operations discussed hereafter.

In particular, the method 600 may begin with a model input operation 601. In particular, in the model input operation 601, multiple LoRA models with varying input shapes are gathered. This diversity in shape may enable a more efficient batching process later. Note that as used herein, the ‘shape’ of a LoRA model embraces, but is not necessarily limited to, a format of token vectors associated with the LoRA model. For example, a token vector may comprise a tensor with the shape [B, T, d], where B is a batch size, T is a sequence length, and d is the dimensionality of the token vector.

The next operation in the method 600 may comprise batching 603 of the LoRA models together, based on their respective output shapes. This batching operation 603 may organize the models in a way that optimizes the parallel processing capabilities of the GPU that will be used to perform the LLM inferencing.

Once the LoRA models have been batched 603, one or more queues may be established 605 based on the output shape of the batched models. That is, each queue may comprise a respective set of LORA models with similar, or identical, output shapes. This queue system ensures that the models are processed in an orderly fashion, maintaining efficiency.

The batched 603 and queued 605 models may then be sent 607 to one or more VGPUs, which may serve as an abstraction of an underlying GPU where parallel inferencing is performed for each of the LoRA models. In particular, one or more VGPU drivers of the GPU May be used to execute the inferencing tasks.

Preparatory to an inferencing process, the LoRA models may be called in the sequence in which they were batched. This ordered approach contributes to the systematic processing of the models. This would be the case if only one VGPU is available. Where multiple VGPUs are available, as suggested in the example of FIG. 6, each instance of a VGPU is utilized by a respective single queue.

Finally, the inferencing is carried out on the LoRA models concurrently, at least in the case where each instance of a VGPU is used to perform a respective inferencing process for a respective LoRA model. This approach may maximize utilization of the GPU. By doing so, the system achieves high throughput and reduces the time required for inferencing.

### C. Further Discussion

As will be apparent from this disclosure, example embodiments may comprise various useful features and aspects, although no embodiment is required to possess any of such features or aspects. The following examples are illustrative, but not exhaustive. An embodiment may comprise a method for efficient batch inferencing with multiple models on a single GPU. As another example, an embodiment may comprise a method for efficient parallel inferencing with multiple model shapes on a single GPU using VGPUs. In contrast with one or more embodiments, conventional approaches employing LoRAs do not implement the batching process disclosed herein. Nor do conventional approaches leverage a single GPU for parallelized workflow using VGPUs.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments. These are presented only by way of example and are not intended to limit the scope of this disclosure or the claims in any way.

Embodiment 1. A method, implemented by a computing system, for improving an efficiency with which a hardware computer processor is utilized, comprising: receiving multiple

LORA (low rank adaptor) models; batching the LoRA models together to generate one or more batches of the LoRA models; creating a respective queue for each of the batches of the LoRA models; calling the LoRA models in a sequence in which the LoRA models were batched; and using only a single GPU (graphics processing unit), performing simultaneous parallel inferencing on all of the LoRA models.

Embodiment 2. The method as recited in any preceding embodiment, wherein the GPU is abstracted by a group of VGPUs (virtual GPUs), each of the VGPUs receiving the batches from a respective one of the queues.

Embodiment 3. The method as recited in any preceding embodiment, wherein the LORA models are batched together based on respective output shapes of the LoRA models.

Embodiment 4. The method as recited in any preceding embodiment, wherein the LoRAs all reside simultaneously in VRAM (virtual random access memory).

Embodiment 5. The method as recited in any preceding embodiment, wherein the LoRA models have different respective input shapes.

Embodiment 6. The method as recited in any preceding embodiment, wherein the batching of the LoRA models optimizes a parallel processing capability of the GPU.

Embodiment 7. The method as recited in any preceding embodiment, wherein a VCPU (virtual central processing unit) of the GPU performs the simultaneous parallel inferencing.

Embodiment 8. The method as recited in any preceding embodiment, wherein each of the LoRAs has been fine-tuned on a different respective task of a common base model.

Embodiment 9. The method as recited in any preceding embodiment, wherein the queues are created by an orchestrator that receives the LoRAs and communicates with the GPU.

Embodiment 10. The method as recited in any preceding embodiment, wherein the LoRAs within a given one of the batches all have the same weights from a common base model.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

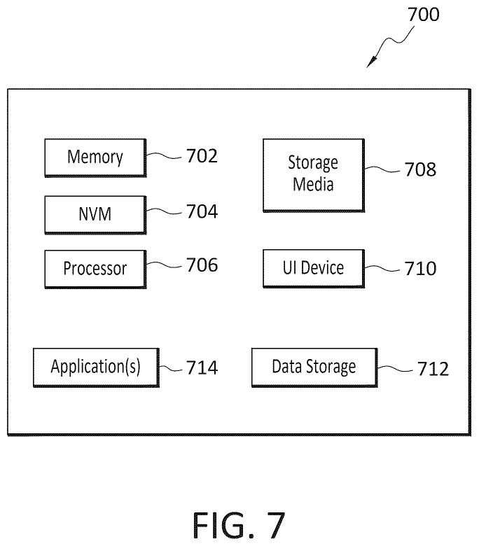

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, implemented by a computing system, for improving an efficiency with which a hardware computer processor is utilized, comprising:
receiving multiple LoRA (low rank adaptor) models;
batching the LoRA models together to generate one or more batches of the LoRA models;
creating a respective queue for each of the batches of the LoRA models;
calling the LoRA models in a sequence in which the LoRA models were batched; and
using only a single GPU (graphics processing unit), performing simultaneous parallel inferencing on all of the LoRA models.

2. The method as recited in claim 1, wherein the GPU is abstracted by a group of VGPUs (virtual GPUs), each of the VGPUs receiving the batches from a respective one of the queues.

3. The method as recited in claim 1, wherein the LoRA models are batched together based on respective output shapes of the LoRA models.

4. The method as recited in claim 1, wherein the LoRAs all reside simultaneously in VRAM (virtual random access memory).

5. The method as recited in claim 1, wherein the LoRA models have different respective input shapes.

6. The method as recited in claim 1, wherein the batching of the LoRA models optimizes a parallel processing capability of the GPU.

7. The method as recited in claim 1, wherein a VCPU (virtual central processing unit) of the GPU performs the simultaneous parallel inferencing.

8. The method as recited in claim 1, wherein each of the LoRAs has been fine-tuned on a different respective task of a common base model.

9. The method as recited in claim 1, wherein the queues are created by an orchestrator that receives the LoRAs and communicates with the GPU.

10. The method as recited in claim 1, wherein the LoRAs within a given one of the batches all have the same weights from a common base model.

11. A non-transitory storage medium having stored therein instructions that are executable by one or more hardware processors to perform operations comprising:
receiving multiple LoRA (low rank adaptor) models;
batching the LoRA models together to generate one or more batches of the LoRA models;
creating a respective queue for each of the batches of the LoRA models;
calling the LoRA models in a sequence in which the LoRA models were batched; and
using only a single GPU (graphics processing unit), performing simultaneous parallel inferencing on all of the LoRA models.

12. The non-transitory storage medium as recited in claim 11, wherein the GPU is abstracted by a group of VGPUs (virtual GPUs), each of the VGPUs receiving the batches from a respective one of the queues.

13. The non-transitory storage medium as recited in claim 11, wherein the LoRA models are batched together based on respective output shapes of the LoRA models.

14. The non-transitory storage medium as recited in claim 11, wherein the LoRAs all reside simultaneously in VRAM (virtual random access memory).

15. The non-transitory storage medium as recited in claim 11, wherein the LoRA models have different respective input shapes.

16. The non-transitory storage medium as recited in claim 11, wherein the batching of the LoRA models optimizes a parallel processing capability of the GPU.

17. The non-transitory storage medium as recited in claim 11, wherein a VCPU (virtual central processing unit) of the GPU performs the simultaneous parallel inferencing.

18. The non-transitory storage medium as recited in claim 11, wherein each of the LoRAs has been fine-tuned on a different respective task of a common base model.

19. The non-transitory storage medium as recited in claim 11, wherein the queues are created by an orchestrator that receives the LoRAs and communicates with the GPU.

20. The non-transitory storage medium as recited in claim 11, wherein the LoRAs within a given one of the batches all have the same weights from a common base model.
